(19) United States
(12) Patent Application Publication
(10) Pub. No.: US 2005/0021891 A1
(43) Pub. Date: Jan. 27, 2005

(54) Controller with small memory card interface conversion USB Interface

(75) Inventors: Hsiang-An Hsieh, Hsindien City (TW); Johnson Lee, Hsindien City (TW)

Correspondence Address: TROXELL LAW OFFICE PLLC;SUITE 1404, 5205 LEESBURG PIKE, FALLS CHURCH, VA, 22041, US

(73) Assignee: Carry Computer Eng. Co., Ltd.

(21) Appl. No.: 10/691,639

(22) Filed: Oct. 24, 2003

(30) Foreign Application Priority Data
Jul. 22, 2003 (TW) 092213367

(51) Int. Cl. G06F 13/10

(52) U.S. Cl. 710/62

(57) ABSTRACT

A controller with small memory card interface switch USB interface, the controller at least comprises a small memory interface connecting with small memory card electric interface in information appliances, an electric interface for imitating standard small memory card, microprocessor of instruction group and communication protocol and an USB interface for connecting with USB memory device; the controller enable the small memory card interface in information appliances to access the pocket disk and relative memory device connecting with USB interface by proper transfer mechanism.

A controller with small memory card interface switch USB interface, the controller at least comprises a small memory interface connecting with small memory card electric interface in information appliances, an electric interface for imitating standard small memory card, microprocessor of instruction group and communication protocol and an USB interface for connecting with USB memory device; the controller enable the small memory card interface in information appliances to access the pocket disk and relative memory device connecting with USB interface by proper transfer mechanism.

The representative drawing of the invention is FIG. 2

The brief description of the representative symbols of the representative drawing:
1. Conversion controller
2. Small memory card interface
12. USB interface
13. Microprocessor
14. Data buffer
15. Program code memory
16. Power manage circuit
17. PLL oscillator circuit
18. Exterior memory interface
2. Small memory card electric interface
3. USB pocket disk and/or relative USB memory device

### THE BRIEF DESCRIPTION OF THE INVENTION

The invention relates to a controller with small memory card interface conversion USB interface, especially to controller that by a proper mechanism enabling USB pocket disk and relative USB storage device, small memory card interface used in information appliances to access information appliances.

### PRIOR TECHNIQUE

The small memory card that use flash memory as storing media has become more and more popular for the following advantages: increase of capacity, decrease of the cost, improvement of the access velocity, and convenience of carry, power saving, repeating read-write, and anti-shake, anti-damp. The small memory card widely be used in pocket digital media device (such as digital camera, digital walkmans, and gradually has reach to photo output device (printer, display, projector) and media product used in home(such as DVD, TV, sounder, refrigerator). Pocket disk with USB interface and other storage device with USB interface, used in the PC field, has been very popular in the media field, but can only used in computer system and cannot be used in above-mentioned information appliances and pocket product. Because the controller in the information appliances and pocket product only use single or more small memory card to save data and cannot support pocket disk with USB interface and other relative USB memory device. It relates to complicate soft communication protocol and hardware source to build USB system port interface into controllers of information appliances and pocket product, so although pocket disk with USB interface takes the wind in the PC field, cannot enter the market of digital information appliances till today. At present, no manufacture develop USB transfer control wafer about small memory card interface, enable the controller wafer to a controller wafer that complete convert only by familiar I/O expansion interface. The effect just relates to system that expanding output interface, adding universal USB interface to support various devices with USB interface (includes MMI device, memory device, communicate device).

But the type of conversion control water itself have no the function of software controlling. The control of itself must be add drive program about the conversion control wafer at the system port, with regard to various USB device added to USB interface, if want the USB device to act there respective drive program is needed to add to the conversion control wafer, so the USB device must relay on one effective processor in computer system to perform the said drive program, and memory with an equivalent capacity is need to store transferred data package. Above-mentioned requirement will influence seriously the development and design of information appliances. It not only increases the complication of design, development of product, but also increases the cost of hardware of product.

In fact, developing drive program that drive various exterior USB interface device is very complicate and time-waste, so the manufactures that design information appliances always select simple one to develop. At the present, the familiars are MMI device and memory device, and USB interface memory device is more popular (please refers to FIG. 4).

If one conversion control wafer can be developed that can convert small memory card interface popular used in digital data filed to USB system interface that support USB pocket disk and the conversion control wafer can support complicate software communicate protocol that is needed to support USB system port interface storage device, that will enable USB pocket product break through the bulwark of limited used in filed of computer and can be used in various pocket digital device and data electric product. In addition, because there are many pocket disk manufacture, so the price of pocket disk is lower than the small memory card which the same capacity as pocket disk. And the pocket disk can easily switch and transfer data with PC. The pocket disk is more convenient then various small memory card that relay on card reader or conversion card in applying.

### THE OBJECT OF THE PRESENT INVENTION

The main aim of the present invention is to provide a controller with small memory card interface conversion USB interface, by a control wafer of small memory card interface conversion USB system port interface, the controller can enable instruction of access data given by digital information appliance product by small memory interface (CF/MS/SD/MMC or any other small memory card etc.) to access USB pocket disk and/or other USB storage device connected with USB interface by proper conversion mechanism, then to access to the result that got convert to access to digital information appliances with small memory card interface by proper conversion course again.

To achieve the above-mentioned aim, the controller with small memory card interface conversion USB interface, which have a conversion controller, the controller at least comprise a small memory interface connecting with small memory card electric interface in information appliance, an electric interface for imitating standard small memory card, microprocessor for converting instruction of information appliance access to small memory card to instruction group and communication protocol that can be accepted by storage device with standard USB interface, instruction group and communication protocol and an USB interface for connecting with USB memory device; so the controller can convert access instruction given by small memory card interface of information appliance to access USB pocket disk using USB interface and relative USB storage device by proper conversion mechanism.

Another object of the present invention is to provide a conversion device with conversion controller. The conversion device is comprised of a body and a conversion controller, and in interior thereof circuit board for electrically connecting with conversion controller, the body be provided connected at proper position with small memory interface and USB interface, so by the conversion device enable small memory card electric interface of information appliances convert to access to USB pocket disk and USB relative storage device.

### BRIEF DESCRIPTION OF THE DRAWINGS

FIG. 1 is a block diagram of information appliance which using the conversion controller of the present invention;

FIG. 2 is function block diagram of the conversion controller of the present invention;

FIG. 3 is function control flow chart of the present invention;

FIG. 4 is conventional information appliances function block diagram.

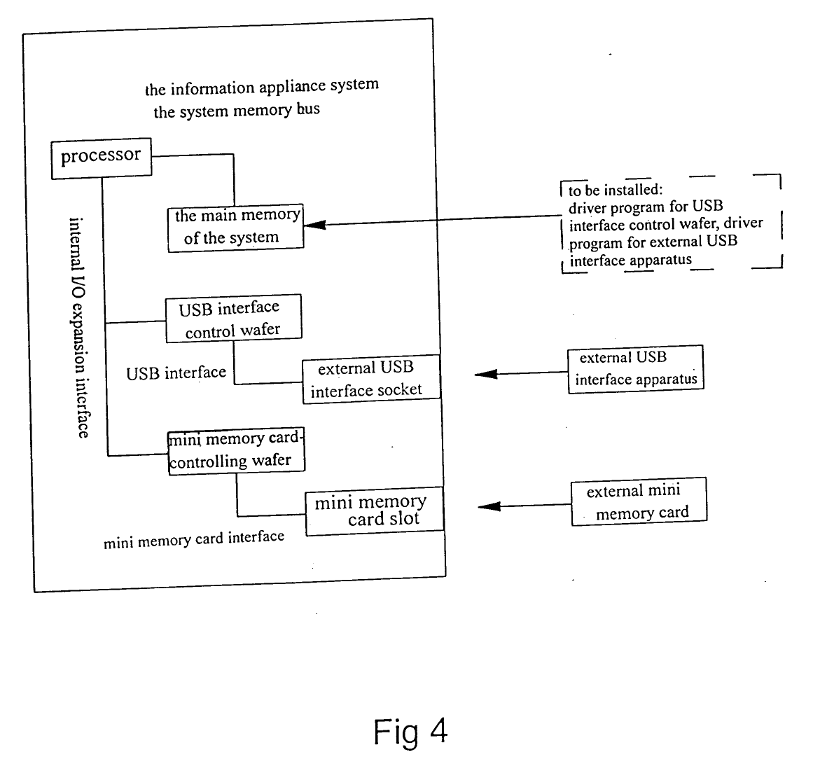

Description of the symbols:
1. Conversion controller
   11. Small memory card interface
   12: USB interface
   13:small processor
   14: data buffer
   15:programe code memory
   16:power manage circuit
   17:PLL oscillator circuit
   18: exterior memory interface
2: small memory electric interface
3:USB pocket disk and/or relative memory device

### DETAILED DESCRIPTION OF THE EMBODIMENTS

The technique content and character of the present invention will now be described in further detail hereinafter, with reference to the accompanying drawings.

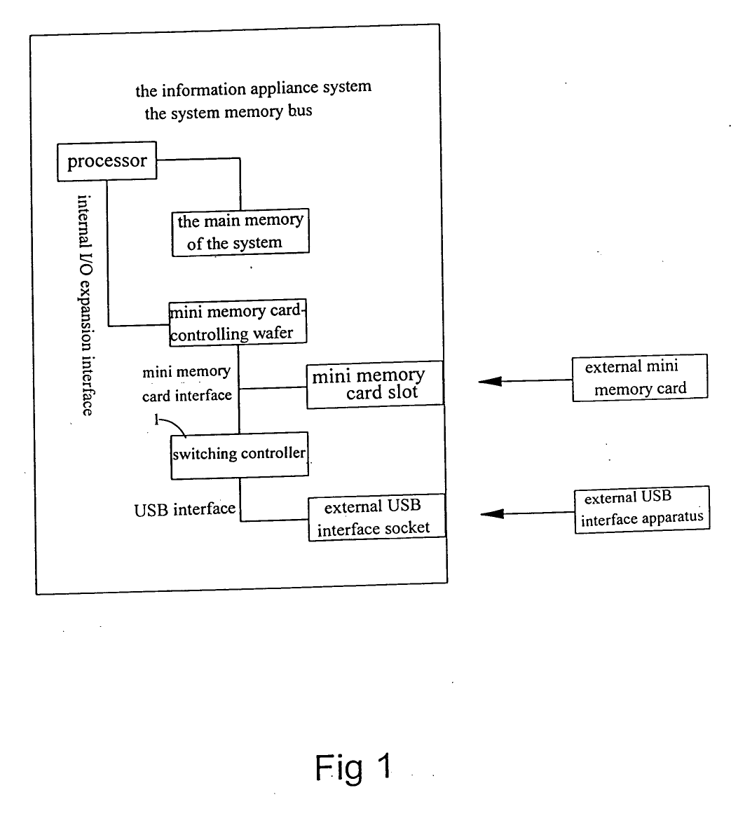

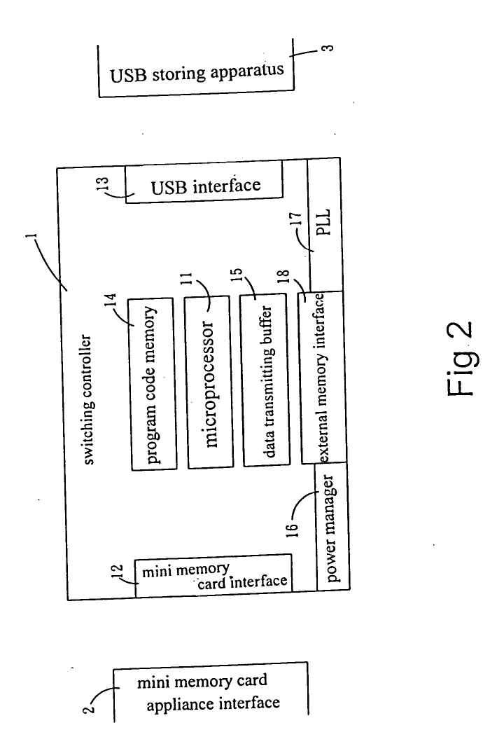

Please refer to FIG. 1 and FIG. 2, the function block diagram of the present invention. In the drawing, the controller with small memory card interface conversion USB interface can be used wildly in various pocket digital product and information appliances. The controller is comprised of at least one small memory card interface 11, an USB interface 12 and a microprocessor 13 connecting between small memory card interface and USB interface 12.

The small memory card interface 11 used for connecting with small memory card electric interface 2 in information appliances. USB interface 12 is used for connecting with exterior USB pocket disk and/or relative USB memory device 3. Said microprocessor 13 is used for simulating electric interface of standard small memory card, instruction group and communication protocol to conversion instruction of information appliances accessing small memory card to instruction group and communication protocol that can be accept by USB interface memory, through that, when information appliances give an access instruction, by the small memory card electric interface 2 connecting with small memory card interface 11, by proper conversion mechanism implemented by microprocessor 13, and using the store space of storage device 3, convert the data that information appliances is accessing to instruction group and communication protocol that can be accepted by standard USB interface storage device, and then access the USB interface storage device connecting externally with USSB interface.

In the embodiments adopted by the present invention, data transmission buffer area 14 is configured between small memory card interface 11 of the conversion controller 1 and USB interface 12, the data transmission buffer area provide small memory card interface 11 and USB interface 12 with data transmission. Conversion controller 1 may be configured with program code memory 15 to receive control microprocessor 13 simulates small memory, to transfer data and to access control program of USB data storage device. In addition, electric power manager circuit 16 and PLL oscillator circuit 17 to maintain the normal operation of conversion controller.

To increase the memory space of external data buffer and to increase the data transfer velocity, so external memory interface 18 is provided in conversion controller of the present, so enable the conversion controller to increase external memory and to increase the capacity of buffer and be used for data transmission buffer.

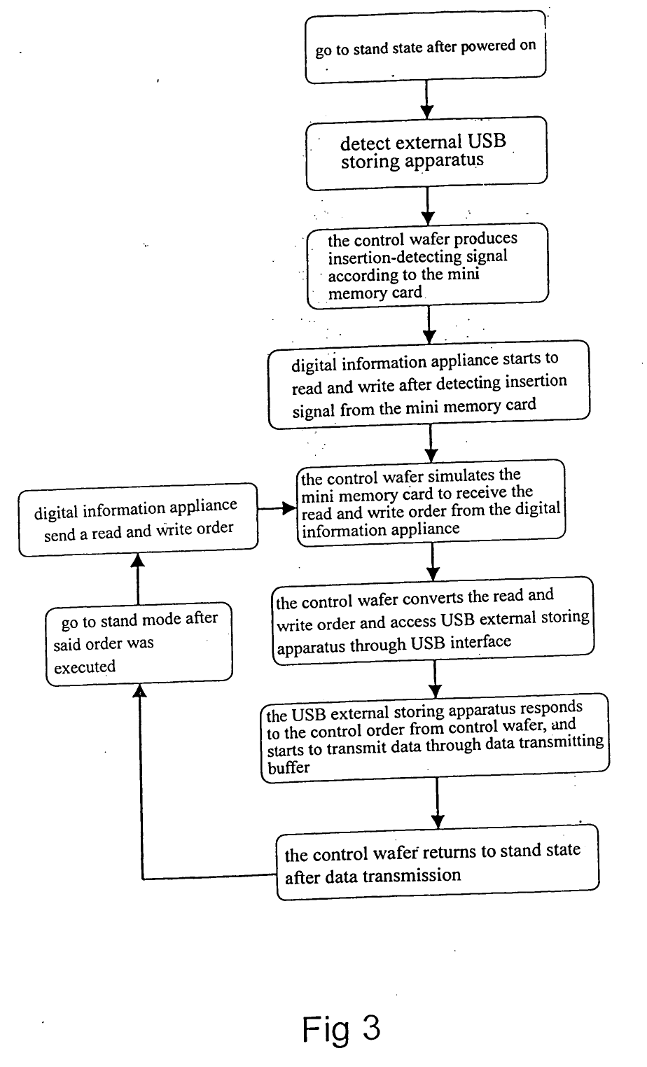

Please refers to FIG. 3, when the present invention access data using information appliances, at first, the power be started and enter into state of awaiting orders, operator plug the external USB storage device, when the information appliances will sensed the plug of external USB storage device, conversion controller subsequently give plug sense signal to information appliances in the standard of small memory card, information appliances begin to read-write after sense the small memory card plug signal, when information appliances give access instruction the microprocessor of conversion controller will simulate small memory card to get the read-write instruction of information appliances, and to convert the received write-read instruction and access exterior USB storage device by USB interface. The exterior USB storage device responses the control instruction of conversion controller and transfer data by data transmission buffer area, the conversion controller will await order when data transferring is finished, at the meantime the information appliances finished executing instruction and enter into state of awaiting order to wait for giving instruction again. The above-mentioned storage device may be relative storage device such as silicon disk machine/hard disk machine/ZIP/MO/disk machine/soft disk machine etc.

Another embodiment adopted in the present invention provides a conversion device configured with said conversion controller (not shown in drawing). The conversion controller comprise of a body and a conversion controller, in which the body may be in the shape of similar small memory card (such as Compact Flash Card, Secure Digital Card, Multi Media Card, Memory Stick Card and small memory card with controller etc.), the present invention will be described with Compact Flash Card as a sample, the similar CF card being provided on one side thereof a small memory card interface to electrically connect with small memory card electric interface of information appliances, and in interior thereof circuit board to electrically connect with conversion controller and said small memory card interface, the USB interface used for connecting with pocket disk (Thumbdrives) and/or relative storage device with USB interface, so by the conversion device enable small memory card electric interface of information appliances convert to access to USB pocket disk and USB relative storage device.

In additional, the disposing of USB interface of said similar CF card may be in-build and USB with cable.

In conclusion, the present invention controller with small memory card interface conversion USB interface can realize the anticipate effect and design aim. The present have not be disclosed and used publicly so accords with the point of patent applying. Now we apply for the application.

The above-mentioned is a preferred embodiment of the present invention. Any change according to the present invention, if the effect thereof is replaceable and not beyond the spirit of the description and drawings, which should in the claim of the present invention.

1. A controller with small memory card interface switch USB interface, the controller at least comprise a small memory interface connecting with small memory card electric interface in information appliances, an electric interface for imitating standard small memory card, microprocessor of instruction group and communication protocol and an USB interface for connecting with USB memory device; the controller enable the small memory card interface in information appliances to access the pocket disk and relative memory device connecting with USB interface by proper transfer mechanism.

2. A controller with small memory card interface switch USB interface as claimed in claim 1, wherein data transfer buffer area being disposed between small memory card interface and USB interface to provide small memory card interface and USB interface with data transmission.

3. A controller with small memory card interface switch USB interface as claimed in claim 1 or 2, wherein conversion controller therein provided with program card memory to storage the controlling program of controlling microprocessor to simulate small memory card, access date, and access control program of USB interface storage device.

4. A controller with small memory card interface switch USB interface as claimed in claim 1 or 2, wherein the conversion controller therein provided with electric power manage circuit and/or PLL oscillator circuit to maintain the normal operation of conversion controller.

5. A controller with small memory card interface switch USB interface as claimed in claim 1, wherein conversion controller therein provided with external memory interface to increase external memory, to increase the capacity of buffer area and used for data transfer buffer area.

6. A controller with small memory card interface switch USB interface as claimed in claim 1, wherein USB storage device is silicon disk machine/hard silicon disk machine/disk/diskette machine.

7. A controller with small memory card interface switch USB interface as claimed in claim 1, wherein the conversion controller maybe in-build in similar small memory card, the similar CF card being provided on one side thereof a small memory card interface to electrically connect with small memory card electric interface of information appliances, and in interior thereof circuit board to electrically connect with conversion controller and said small memory card interface, the USB interface used for connecting with pocket disk (Thumbdrives) and/or relative storage device with USB interface, so by the conversion device enable small memory card electric interface of information appliances conversion to access to USB pocket disk and USB relative storage device.

8. A controller with small memory card interface switch USB interface as claimed in claim 7, wherein the similar memory card may be CF card, SD card, MMC card, MS card and small memory card with controller.

9. A controller with small memory card interface switch USB interface as claimed in claim 1, wherein USB interface of similar memory card is in-build and USB style with cable.
